(19) United States
(12) Patent Application Publication
(10) Pub. No.: US 2014/0197561 A1
(43) Pub. Date: Jul. 17, 2014

(54) DETECTION OF CHANGE IN ORIENTATION OF CENTRAL AXIS OF PLATEN ASSEMBLY

(71) Applicant: Roman Robert Pirog, Caledon East (CA)

(72) Inventor: Roman Robert Pirog, Caledon East (CA)

(21) Appl. No.: 14/117,142

(22) PCT Filed: May 29, 2012
(86) PCT No.: PCT/CA12/50353

§ 371 Date: Nov. 12, 2013

Related U.S. Application Data
(60) Provisional application No. 61/498,727, filed on Jun. 20, 2011.

(51) Int. Cl. B29C 33/30

(52) U.S. Cl. CPC B29C 33/303
USPC 264/40.1; 425/150

(57) ABSTRACT

A molding system (100), comprising: a platen assembly (102) having: (i) a mold-support face (104), and (ii) a central axis (106) extending orthogonally from the mold-support face (104); and a detection assembly (108) being positioned relative to the central axis (106), the detection assembly (108) being configured to detect, at least in part, an amount of change in orientation of the central axis (106).

### TECHNICAL FIELD

An aspect generally relates to (and is not limited to) molding systems.

### BACKGROUND

U.S. Pat. No. 6,171,092 (GALT, et al.) discloses a platen sensing and alignment apparatus. The apparatus is for detecting whether platens in a mold clamp remain parallel throughout an entire molding process. The apparatus includes a frame, a first platen having a surface orthogonal to a predetermined axis, a second platen having a surface opposing the first platen, the second platen being reciprocatable along the predetermined axis, actuating cylinders for reciprocating the second platen along the predetermined axis, and positions transducers for electromagnetically detecting the positions of a plurality of points on the surface of the second platen. The method includes the steps of emitting first and second electromagnetic interrogation pulses from a controller, transmitting the first pulse to a first transducer rod fixed relative to the first platen, and transmitting the second pulse to a second transducer rod fixed relative to the first platen and parallel to the first transducer rod, generating a first return signal when the first pulse reaches a magnet disposed adjacent to the first transducer rod and fixed relative to one end of the second platen, and generating a second return signal when the second pulse reaches a magnet disposed adjacent to the second transducer and fixed relative to an opposite end of the second platen, transmitting each of the first and second return signals to the controller, measuring the time elapsed between the emission of each pulse and the arrival of the corresponding return signal at the controller, and determining, based on the times elapsed, whether the opposing surfaces of the second platen and the first platen are substantially parallel.

United States Patent Application Number 2008/0174038 (GLAESENER, et al.) discloses a platen assembly, a molding system and a method for platen orientation and alignment. Gravitation and inertial effects on platen verticality and sagging are compensated by an anti-tilt actuator. Specifically, and particularly with the location of a heavy weight mold half on a platen, platen tilting and front face sagging occurs as a consequence of at least one of: i) the overhanging mass of the mold half; ii) inertia effects caused by stroking of the platen. A hydraulic actuator secured beneath the platen is either set to offset only gravitationally-related sagging of the mold half by providing a compensating upward force (relative to a stable clamp base), or otherwise its upward force can be dynamically adjusted also to compensate for swaying or tilting of the mold-platen assembly caused by stroke cylinder operation and related inertia/momentum effects. Preferably, a level sensor measures and communicates a degree of horizontalness/verticality of the platen to a machine controller which, in turn, generates a control signal to cause variation in cylinder pressure in the anti-tilt actuator, thereby achieving substantially continuous alignment between the mold halves and reduced component wear.

### SUMMARY

The inventor has researched a problem associated with known molding systems that inadvertently manufacture bad-quality molded articles or parts. After much study, the inventor believes he has arrived at an understanding of the problem and its solution, which are stated below, and the inventor believes this understanding may not be generally known to the public.

Platen parallelism extends the life of a mold assembly, and improves quality of molded articles. Known molding systems place the onus on the machine operator to ensure that the molding system is properly maintained and routinely checked for parallelism of the mold-support surfaces of the platens, which are used to support a mold assembly. This operation is a manual process and requires machine down time and proper skill and instrumentation to perform. These factors are reasons why platen parallelism may be neglected. Failure to maintain acceptable platen parallelism may result in uneven engagement of mold-support faces of the platens, and contributes to accelerated mold wear. In addition, failure to maintain acceptable platen parallelism may result in uneven loading of the mold assembly, resulting in molded part defects such as onset of mold flash.

According to one aspect, there is provided a molding system (100), comprising: a platen assembly (102) having: (i) a mold-support face (104), and (ii) a central axis (106) extending orthogonally from the mold-support face (104); and a detection assembly (108) being positioned relative to the central axis (106), the detection assembly (108) being configured to detect, at least in part, an amount of change in orientation of the central axis (106).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

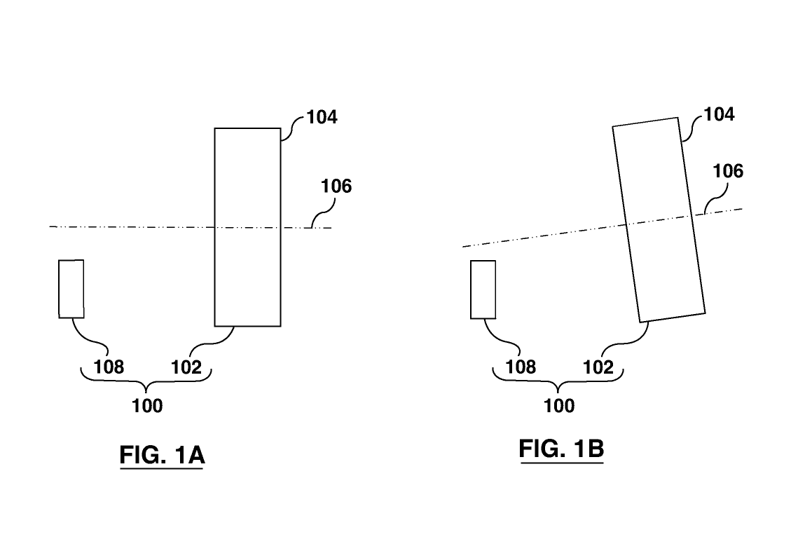

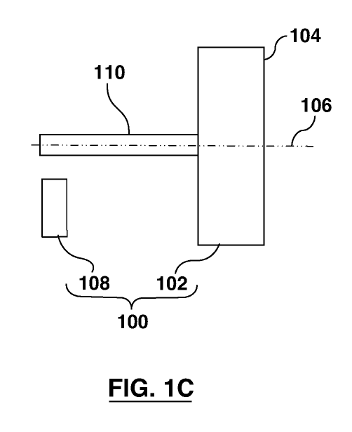

FIGS. 1A, 1B, 1C, 2A, 2B, 3A, 3B depict schematic representations of examples of a molding system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1A, 1B, 1C, 2A, 2B, 3A, 3B depict the schematic representations of examples of the molding system (100). The molding system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

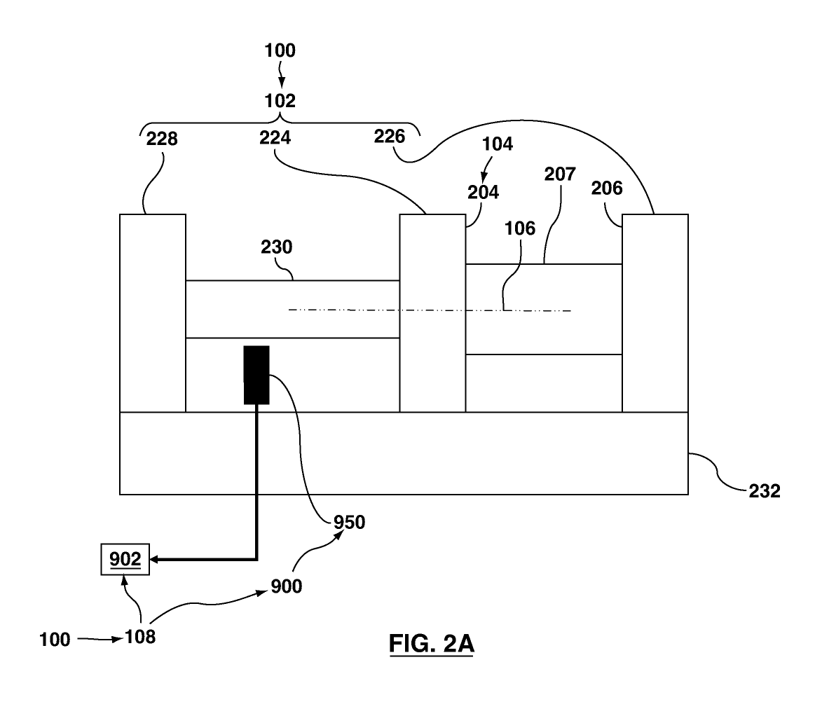

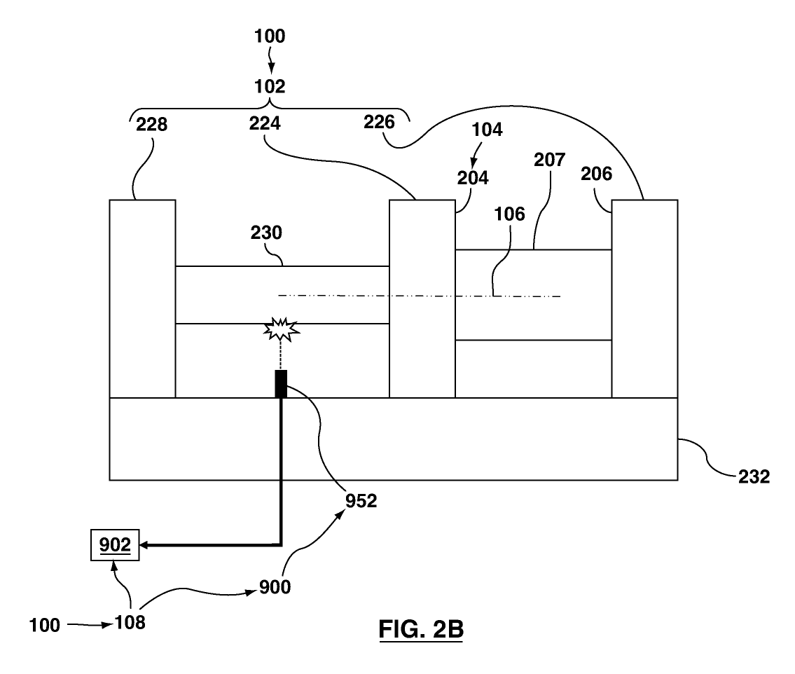

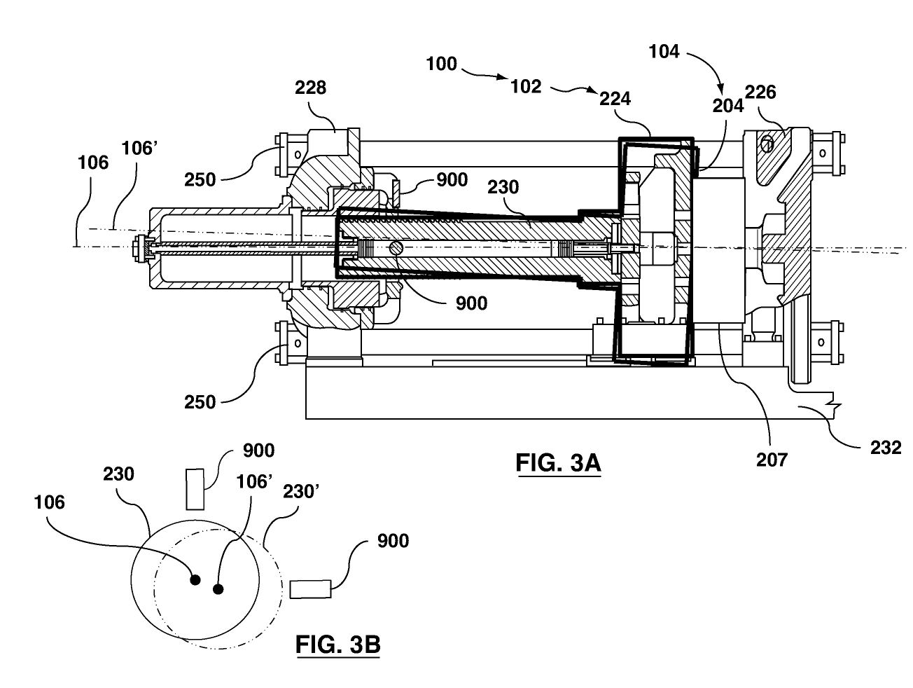

With reference to all of the FIGS (FIGS. 1A and 1B depict a simplified example), the molding system (100) includes (and is not limited to) a combination of: (i) a platen assembly (102), and (ii) a detection assembly (108). The platen assembly (102) has (and is not limited to): (i) a mold-support face (104), and (ii) a central axis (106) extending orthogonally from the mold-support face (104). The detection assembly (108) is positioned relative to the central axis (106). The detection assembly (108) is configured to detect, at least in part, an amount of change in orientation of the central axis (106). The amount of change in orientation of the central axis (106) may include a change (at least in part) in position of the central axis (106). It will be appreciated that the detected amount of change in orientation of the central axis (106) may include (and is not limited to) a change in a position, at least in part (or a portion thereof), of the central axis (106). It will be appreciated that the mold-support face (104) is configured to support, at least in part, a portion of a mold assembly (207), which is depicted in FIGS. 2A, 2B, 3A, 3B. A technical effect of the molding system (100) is that for the case where change in orientation of the central axis (106) is detected (that is, made, identified or determined), unintentional wearing of the mold assembly (207) may be reduced provided that mitigating action or steps are conducted soon after detection is made (such as an adjustment to the set-up of the molding system (100) that make correct for the orientation of the central axis (106)). It will be appreciated that the mold assembly (207) is a tool that requires, from time to time, replacement or refurbishment due to wear and tear. Extending the useful operational life of the mold assembly (207) helps to advantageously reduce the costs associated with operating and maintaining the molding system (100) for manufacturing molding articles. Once change in orientation of the central axis (106) is detected, the user or operator of the molding system (100) may then take appropriate mitigating action or steps (as may be required or when scheduled) to determine the cause for the detection of change in orientation of the central axis (106). The root-cause problem analysis may include, by way of example, assistance from the vendor of the molding system (100) and/or access to a knowledge database, such as a users manual, a reference manual, an on-line knowledge database, etc. The molding system (100) is a system that operates in accordance with a molding process of manufacturing by shaping a pliable raw material using a mold assembly. Injection molding is a manufacturing process for producing parts from thermoplastic or thermosetting plastic materials. Material is fed into a heated barrel, mixed, and forced into a mold cavity where it cools and hardens to the configuration of the mold cavity defined by a mold assembly. After a product is designed, usually by an industrial designer or an engineer, molds are made by a moldmaker (or toolmaker) from metal, usually either steel or aluminum, and precision-machined to form the features of the desired part. Injection molding is widely used for manufacturing a variety of parts, from the smallest component to entire body panels of cars. A mold assembly is a hollowed-out block that is filled with a liquid like material. The liquid hardens or sets inside the mold, adopting its shape. The manufacturer who makes the molds is called the moldmaker. A release agent is typically used to make removal of the hardened/set substance from the mold easier. An injection molding machine, which is an example of the molding system (100), is also known as an injection press, is a machine for manufacturing plastic products by the injection molding process. It consists of two main parts: an injection unit and a clamping unit. Injection molding machines can fasten the molds in either a horizontal or vertical position. The majority of machines are horizontally oriented, but vertical machines are used in some niche applications such as insert molding, allowing the machine to take advantage of gravity. There are many ways to fasten the tools to the platens, the most common being manual clamps (both halves are bolted to the platens); however hydraulic clamps (chocks are used to hold the tool in place) and magnetic clamps are also used. The magnetic and hydraulic clamps are used where fast tool changes are required. Sometimes, a molding system (100) may be referred to as a machine. Machines are classified primarily by the type of driving systems they use: hydraulic, mechanical, electric, or hybrid. Hydraulic presses have historically been the only option available to molders until the first all-electric injection molding machine was introduced. Mechanical type machines may use the toggle system for building up tonnage on the clamp side of the machine. Tonnage is required on all machines so that the clamp side of the machine does not open (i.e. tool half mounted on the platen) due to the injection pressure. If the tool half opens up it will create flash in the plastic product. Reliability of mechanical type of machines is more as tonnage built during each cycle is the same as compared to hydraulic machines. Hybrid injection molding machines claim to take advantage of the best features of both hydraulic and electric systems, but in actuality use almost the same amount of electricity to operate as a standard hydraulic. A robotic arm is often used to remove the molded components; either by side entry or top entry, but it is more common for parts to drop out of the mold, through a chute and into a container.

Referring now to FIG. 1A, there is a depicted a case where the amount of change in orientation of the central axis (106) is within an acceptable range or limit or tolerance. That is, the amount of change in orientation detected is zero as depicted in FIG. 1A. That is, the orientation of the central axis (106) remains substantially parallel with the floor or ground as a point of reference. The orientation depicted in FIG. 1A may be treated as a base-line orientation for comparison purposes. The central axis (106) is positioned centrally through the platen assembly (102). Referring now to FIG. 1B, there is a depicted a case where the amount of change in orientation of the central axis (106) is not within the acceptable range or limit or tolerance. That is, the central axis (106) is detected and is depicted as being changed in orientation, relative to the orientation as depicted in FIG. 1A (for example). It will be appreciated that orientation is defined as a location or position relative to a reference. The platen assembly (102) may include any type of platen. A platen is a structure on which mold halves of a mold assembly may be attached. A movable platen is a structure of a molding system (100) that is movable by a hydraulic ram or a mechanical toggle (for example). A stationary platen is a structure that to which a mold half may be secured, and this type of platen does not move during normal operation of the molding system (100).

Referring now to FIG. 1C, there is depicted an example of the molding system (100), in which a cantilevered member (110) extends from the platen assembly (102) along the central axis (106). The detection assembly (108) is placed at a position that is set apart from the platen assembly (102) and along the cantilevered member (110). Generally, the detection assembly (108) is positioned relative to the cantilevered member (110). The detection assembly (108) is configured to detect, at least in part, an amount of change in orientation of the cantilevered member (110), whether the change in orientation is a vertically-aligned change, a horizontally-aligned change, or a combination of horizontally-aligned change and vertically aligned change. The definition of cantilever is a projecting structure that is supported at one end and carries a load, at least in part, at a position set apart from the end that is supported or along its length (at least in part).

Referring now to FIGS. 2A, 2B, 3A, there are depicted other examples of the molding system (100), in which the mold-support face (104) includes (and is not limited to): (i) a stationary mold-support face (206), and (ii) a movable mold-support face (204) facing the stationary mold-support face (206). The movable mold-support face (204) and the stationary mold-support face (206) are configured to support a mold assembly (207). Detection of change in orientation of the central axis (106) is a measure of mold-face parallelism between the stationary mold-support face (206) and the movable mold-support face (204). The stationary mold-support face (206) faces the movable mold-support face (204).

According to the specific example as depicted in FIGS. 2A and 2B, the molding system (100) is further adapted so that the platen assembly (102) includes (and is not limited to): (i) a movable platen (224), (ii) a stationary platen (226), and (iii) a clamp-column supporting platen (228). FIGS. 2A and 2B depicts cross sectional view of the molding system (100) from an operator side view. The clamp-column supporting platen (228) supports axial movement of the clamp column (230). The movable platen (224) has the movable mold-support face (204). The stationary platen (226) has the stationary mold-support face (206). The movable platen (224) is movable relative to the stationary platen (226). The clamp-column supporting platen (228) is set apart from the movable platen (224). The clamp column (230) is configured to move the movable platen (224) relative to the stationary platen (226), and is also configured to apply a clamp tonnage to the movable platen (224) for the case where the mold assembly (207) is closed. By way of example, the cantilevered member (110) includes (and is not limited to) a clamp column (230) extending between the movable platen (224) and the clamp-column supporting platen (228). A machine base (232) is configured to support the movable platen (224), the stationary platen (226), and the clamp-column supporting platen (228). According to an option, the detection assembly (108) includes (and is not limited to): a sensor assembly (900), and a controller assembly (902) connected with the sensor assembly (900). The controller assembly (902) includes (and is not limited to): a controller-usable medium tangibly embodying controller-executable instructions configured to direct the controller assembly (902) to perform certain tasks or a method. The method of operating the molding system (100) includes (and is not limited to): (i) receiving an indication signal from the sensor assembly (900), the indication signal configured to provide detection of change in orientation of the central axis (106), and (ii) provide a warning alarm indication that indicates detection of change in orientation of the central axis (106) is outside of an acceptable tolerance range. The sensor assembly (900) is an assembly that receives a stimulus and responds to the stimulus. The controller assembly (902) is an assembly that is concerned with controlling the operation of a device. It will be appreciated that the warning alarm indication does not have to be used to stop normal operation of the molding system (100) and may be used to merely provide a warning to the machine operator. However, on the other hand, for some cases, it may be justified to use the warning alarm indication to stop normal operation of the molding system (100) if so desired.

Referring specifically to FIG. 2A, the sensor assembly (900) has or includes (and is not limited to) a proximity sensor assembly (950). Referring specifically to FIG. 2B, the sensor assembly (900) has (and is not limited to) a laser assembly (952). Several sensor technologies may be used for measuring displacement of the clamp column (230), such as (by way of example and not limited to): mechanical, inductive, eddy current, laser, a displacement sensor, etc. The sensor assembly (900) may be added or connected to a portion of the clamp column (230), so that the sensor assembly (900) may measure (to a desired level of accuracy) proximity of the clamp column (230) under mold stroke, tonnage and decompression cycles of the molding system (100). The clamp column (230) has an inherent magnification through its cantilever design. As the movable platen (224) settles to parallel operation with the stationary platen (226) under cycles of the molding system (100), such as stoke, tonnage and/or decompression stages, the change in orientation of the central axis (106) may be detected as lateral, vertical or combination of lateral and vertical as the clamp column (230) is moved along the stroke axis, which is the central axis (106). The change in orientation of the central axis (106) is magnified by the clamp column (230) at a spot or position of the clamp column (230) that is located spaced apart from the movable platen (224). The measurement may consist of amplitude, as well as orientation obtained by the multiple sensors mounted on a part of the clamp column (230).

Monitoring of platen parallelism, as the molding system (100) is operated to manufactured molded articles, helps reduce down time of the molding system (100). Without the detection assembly (108), in order to detect platen parallelism, the molding system (100) would otherwise have to be shut down so that manual inspection of the molding system (100) may be conducted. As well, because of the automated nature of the detection assembly (108), sensed data may be collected and monitored over time to provide an indication of stability of platen parallelism and/or shifts detected for platen parallelism over time (that is, the detected change in orientation of the central axis (106)). It will be appreciated that the controller assembly (902) may be configured to provide closed loop control in order to respond to the platen parallelism sensed date obtained by the sensor assembly (900), and also configured to automatically adjust and to compensate for the case where out-of-parallelism data is detected. The controller assembly (902) may be configured to provide or to display platen parallelism sensed data (such as on a human machine interface) as the clamp column (230) passes during mold stroke and application of tonnage, as well as the reverse (during decompression and mold open) if so desired. The output of the sensor assembly (900) may be profiled and base-lined during stroking of the movable platen (224). Once the mold assembly (207) is closed, deflection of the clamp column (230) proximate to the sensor assembly (900) is detected, and then monitoring may be continued under application of clamp tonnage, by way of the clamp column (230), during normal molding operation of the molding system (100). To accommodate for machine-to-machine variations, such as tolerance and assembly stack-ups, a calibration pass may be run by mapping the profile of the clamp column (230), or the central axis (106), under full mold stroke. The baseline profile may be used as a zero point reference for measurements made once the mold assembly (207) is installed on the stationary mold-support face (206) and the movable mold-support face (204) of the stationary platen (226) and the movable platen (224), respectively.

Referring now to FIGS. 3A, 3B, there is depicted another example of the molding system (100). FIG. 3A depicts a cross-sectional view from a top side of the molding system (100). FIG. 3B depicts a cross sectional view of the central axis (106) and the clamp column (230) for the case of zero or no change detected for orientation of the central axis and for the case of a detected change for orientation of the central axis (106). Tie bars (250) extend from the clamp-column supporting platen (228) to the movable platen (224) and over to the stationary platen (226). The movable platen (224) moves between the stationary platen (226) and the clamp-column supporting platen (228). The clamp-column supporting platen (228) supports linear movement of the clamp column (230). The end of the clamp column (230) is attached of the movable platen (224). For the case where the amount of change in orientation of the central axis (106) is zero, the central axis (106) extends along a central axis of the clamp column (230) and in parallel with the machine base (232). For the case where the amount of change in orientation of the central axis (106) is non-zero (that is, this is a condition of change in orientation), the central axis (106′) is aligned at an angle to the central axis (106) associated with zero change in orientation. It will be appreciated that the detected amount of change in orientation of the central axis (106) may include (and is not limited to) a change in a position, at least in part (or a portion thereof), of the central axis (106).

Referring now to FIG. 3B, there is depicted, by way of example, sensor mounting locations. These locations may be used to capture vertical and lateral deflection of the clamp column (230). Platen parallelism, as depicted in FIG. 3A (exaggerated for convenience), is detected (for example) through proximity sensors placed along multiple axes relative to the central axis (106). Sensors may measure vertical and lateral movement of the clamp column (230) for a combined vector indication that provides an indication of the amount of parallelism of the mold-support faces of the movable platen (224) and the stationary platen (226).

By mounting the sensor assembly (900) to the clamp column (230), advantageous magnification of the amount of change in orientation of the central axis (106) is achieved. The sensor assembly (900) may monitor axial alignment of the clamp column (230) during stroke, and any shift to platen parallelism during application of tonnage is detected. The vector sum of the vertical and lateral deflections during mold engagement may be used to indicate direction where platen parallelism (that is: orientation of the central axis (106)), needs to be corrected, as well as the magnitude of the correction that may be required. The arrangement described above may require that the mold assembly (207) has been manufactured in accordance with an acceptable level of parallelism. If this is not the case, a non-parallel mold will be detected by the detection assembly (108) and it will provide awareness to the operator that the machine mold assembly is not parallel and could lead to accelerated wear or the tool or damage to the molding system (100).

The detection assembly (108), in accordance with an option, includes (and is not limited to) proximity measurement sensors configured to monitor separation of the clamp column (230) during at least part of the molding cycle of the molding system (100), such as mold close, tonnage, decompression and mold open, to monitor parallelism of the platen faces and mold engagement. For the case where a simplified arrangement may be justified or warranted (in accordance with an option), the detection assembly (108) operates to detect the change in orientation of the central axis (106) only during mold engagement; that is, when the mold assembly (207) is closed as depicted in FIG. 3A. Measured changes in separation indicate platen parallelism is out of alignment both in magnitude and in direction. This information provides feedback to a machine operator. Adjusting for platen parallelism may be a manual operation requiring machine down time in order to execute the adjustment (perhaps during a scheduled maintenance period). This detection assembly (108) improves productivity of the molding system (100). By using the detection assembly (108), periodic alignment data collection may be used for detecting deviation and settling over time of the platen parallelism. It will be appreciated that the controller assembly (902) may be configured to automatically adjust configuration of the molding system (100) to correct for detected deviation of platen parallelism outside of a tolerance limit.

In summary, it will be appreciated that the detection assembly (108) improves monitoring of platen parallelism (by way of example). The detection assembly (108) may allow platen-parallelism data to be obtained by the controller assembly (902), such as a machine controller, while the machine controller operates the molding system (100), thus reducing down time of the molding system (100) and increasing productivity. For the case where the detection assembly (108) is installed on the molding system (100), reduced operator skill requirement may be realized as well. The benefits of the detection assembly (108) are longer mold wear life and molded part quality.

### ADDITIONAL DESCRIPTION

The following clauses are offered as further description of the examples of the molding system (100): Clause (1): a molding system (100), comprising: a platen assembly (102) having: (i) a mold-support face (104), and (ii) a central axis (106) extending orthogonally from the mold-support face (104); and a detection assembly (108) being positioned relative to the central axis (106), the detection assembly (108) being configured to detect , at least in part, a change in orientation of the central axis (106). Clause (2): the molding system (100) of any clause mentioned in this paragraph, further comprising: a cantilevered member (110) extending from the platen assembly (102) along the central axis (106), and wherein the detection assembly (108) is positioned set apart from the platen assembly (102), and the detection assembly (108) is positioned relative to the cantilevered member (110), the detection assembly (108) is configured to detect, at least in part, the change in orientation of the cantilevered member (110). Clause (3): the molding system (100) of any clause mentioned in this paragraph, wherein: the mold-support face (104) includes: (i) a stationary mold-support face (206); and (ii) a movable mold-support face (204) facing the stationary mold-support face (206), and detection of change in orientation of the central axis (106) is a measure of mold-face parallelism between the stationary mold-support face (206) and the movable mold-support face (204). Clause (4): the molding system (100) of any clause mentioned in this paragraph, wherein: the mold-support face (104) includes a movable mold-support face (204) facing a stationary mold-support face (206), the movable mold-support face (204) and the stationary mold-support face (206) configured to support a mold assembly (207); the platen assembly (102) includes: (i) a movable platen (224) having the movable mold-support face (204), (ii) a stationary platen (226) having the stationary mold-support face (206), the movable platen (224) being movable relative to the stationary platen (226), and (iii) a clamp-column supporting platen (228); and the cantilevered member (110) includes a clamp column (230) extending between the movable platen (224) and the clamp-column supporting platen (228).

Clause (5): the molding system (100) of any clause mentioned in this paragraph, wherein: the detection assembly (108) includes: a sensor assembly (900); and a controller assembly (902) being connected with the sensor assembly (900). Clause (6): the molding system (100) of any clause mentioned in this paragraph, wherein: the controller assembly (902) includes: a controller-usable medium tangibly embodying controller-executable instructions being configured to direct the controller assembly (902) to: (i) receive an indication signal from the sensor assembly (900), the indication signal being configured to provide detection of change in orientation of the central axis (106); and (ii) provide a warning alarm indication indicating that the detection of the change in orientation of the central axis (106) is outside of an acceptable tolerance range. Clause (7): the molding system (100) of any clause mentioned in this paragraph, wherein: the detection assembly (108) includes: a sensor assembly (900) having a proximity sensor assembly (950). Clause (8): the molding system (100) of any clause mentioned in this paragraph, wherein: the detection assembly (108) includes: a sensor assembly (900) having a laser assembly (952). Clause (9): the molding system (100) of any clause mentioned in this paragraph, wherein: the controller assembly (902) includes: a controller-usable medium tangibly embodying controller-executable instructions being configured to direct the controller assembly (902) to: (i) receive an indication signal from the sensor assembly (900), the indication signal being configured to provide detection of change in orientation of the central axis (106); and (ii) provide a warning alarm indication indicating that the detection of the change in orientation of the central axis (106) is outside of an acceptable tolerance range.

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A molding system (100), comprising:
a platen assembly (102) having: (i) a mold-support face (104), and (ii) a central axis (106) extending orthogonally from the mold-support face (104); and
a detection assembly (108) being positioned relative to the central axis (106), the detection assembly (108) being configured to detect, at least in part, a change in orientation of the central axis (106).

2. The molding system (100) of claim 1, further comprising:
a cantilevered member (110) extending from the platen assembly (102) along the central axis (106), and
wherein the detection assembly (108) is positioned set apart from the platen assembly (102), and the detection assembly (108) is positioned relative to the cantilevered member (110), the detection assembly (108) is configured to detect, at least in part, the change in orientation of the cantilevered member (110).

3. The molding system (100) of claim 1, wherein:
the mold-support face (104) includes: (i) a stationary mold-support face (206); and (ii) a movable mold-support face (204) facing the stationary mold-support face (206), and detection of change in orientation of the central axis (106) is a measure of mold-face parallelism between the stationary mold-support face (206) and the movable mold-support face (204).

4. The molding system (100) of claim 2, wherein:
the mold-support face (104) includes a movable mold-support face (204) facing a stationary mold-support face (206), the movable mold-support face (204) and the stationary mold-support face (206) configured to support a mold assembly (207);
the platen assembly (102) includes: (i) a movable platen (224) having the movable mold-support face (204), (ii) a stationary platen (226) having the stationary mold-support face (206), the movable platen (224) being movable relative to the stationary platen (226), and (iii) a clamp-column supporting platen (228); and
the cantilevered member (110) includes a clamp column (230) extending between the movable platen (224) and the clamp-column supporting platen (228).

5. The molding system (100) of claim 1, wherein:
the detection assembly (108) includes:
a sensor assembly (900); and
a controller assembly (902) being connected with the sensor assembly (900).

6. The molding system (100) of claim 5, wherein:
the controller assembly (902) includes:
a controller-usable medium tangibly embodying controller-executable instructions being configured to direct the controller assembly (902) to:
(i) receive an indication signal from the sensor assembly (900), the indication signal being configured to provide detection of change in orientation of the central axis (106); and
(ii) provide a warning alarm indication indicating that detection of the change in orientation of the central axis (106) is outside of an acceptable tolerance range.

7. The molding system (100) of claim 1, wherein:
the detection assembly (108) includes:
a sensor assembly (900) having a proximity sensor assembly (950).

8. The molding system (100) of claim 1, wherein:
the detection assembly (108) includes:
a sensor assembly (900) having a laser assembly (952).

9. The molding system (100) of claim 1, wherein:
the detection assembly (108) operates to detect the change in orientation of the central axis (106) only during mold engagement.

10. A method of operating a molding system (100), the method comprising:
detecting an amount of change in orientation of a central axis (106) relative to a mold-support face (104) of a platen assembly (102) having the central axis (106) extending orthogonally from the mold-support face (104).

11. A controller assembly (902) configured to interface with the detection assembly (108) of the molding system (100) of claim 1.

12. A controller assembly (902) for the molding system (100) of claim 1, the controller assembly (902) including:
a controller-usable medium tangibly embodying controller-executable instructions being configured to direct the controller assembly (902) to:
(i) receive an indication signal from the detection assembly (108), the indication signal being configured to provide detection of change in orientation of the central axis (106); and
(ii) provide a warning alarm indication indicating that the detection of change in orientation of the central axis (106) is outside of an acceptable tolerance range.
